(19) United States
(12) Patent Application Publication
(10) Pub. No.: US 2020/0116745 A1
(43) Pub. Date: Apr. 16, 2020

(54) METHOD OF OPERATING AN ANALYTICAL LABORATORY

(71) Applicant: Roche Diagnostics Operations, Inc., Indianapolis, IN (US)

(72) Inventors: Matthias Frenzel, Heidelberg (DE); Marco Maetzler, Belmont, CA (US); Andrew McCaughey, Baar (CH)

(73) Assignee: Roche Diagnostics Operations, Inc., Indianapolis, IN (US)

(21) Appl. No.: 16/596,805

(22) Filed: Oct. 9, 2019

(30) Foreign Application Priority Data
Oct. 16, 2018 (EP) 18200635.3

(51) Int. Cl. G01N 35/00; G01N 35/02

(52) U.S. Cl. CPC G01N 35/0092; G01N 35/02

(57) ABSTRACT

A method of operating an analytical laboratory is disclosed. The method comprises receiving and identifying a biological sample by a pre-analytical laboratory instrument, retrieving corresponding test order(s), determining a target laboratory instrument for each of the test order(s), determining whether the target laboratory instrument(s) is ready to carry out the test order, transmitting a readiness command to the target laboratory instrument(s) if the target laboratory instrument is not ready, executing instructions of the readiness command by the target laboratory instrument, instructing the target laboratory instrument(s) to process the biological sample according to the test order if the target laboratory instrument is ready to carry out the test order, and processing the biological sample by the target laboratory instrument(s) according to the test order as instructed.

### CROSS-REFERENCE TO RELATED APPLICATIONS

This application claims priority to EP 18200635.3, filed Oct. 16, 2018, which is hereby incorporated by reference.

### BACKGROUND

The present disclosure generally relates to a computer implemented method of operating an analytical laboratory such as, for example, an in-vitro diagnostic laboratory.

In vitro diagnostic testing has a major effect on clinical decisions as well as providing physicians with pivotal information. In analytical laboratories such as, for example, in-vitro diagnostic laboratories, a multitude of analyses on biological samples are executed by laboratory instruments in order to determine physiological and biochemical states of patients which can be indicative of a disease, nutrition habits, drug effectiveness, organ function and the like.

According to established laboratory procedures in complex analytical laboratories, a plurality of instruments process biological samples according to test orders, each test order defining one or more processing steps to be carried out on the biological sample. After the biological sample has been received and identified by a pre-analytical laboratory instrument, a control unit retrieves the corresponding test orders and determines which instruments (referred hereafter as target instrument(s)) are required to process the biological sample according to the test order(s). Having identified the target instrument(s), the control unit instructs the target laboratory instrument(s) to process the biological sample according to the test order(s).

It has been observed that significant delays occur between receipt respectively processing of the biological sample by the target laboratory instrument(s). Such delays considerably affect the turn-around-time (TAT) of biological samples, that is the time between receipt of a biological sample and completion of the corresponding test order(s).

Hence, there is a need for a method of operating an analytical laboratory such as, an analytical laboratory system in order to provide reduced and/or predicable Turn-Around-Times (TATs) for processing biological samples.

### SUMMARY

According to the present disclosure, a method of operating an analytical laboratory is disclosed. The method can comprise receiving and identifying a biological sample by a pre-analytical laboratory instrument of the analytical laboratory, retrieving an order list from a database, the order list comprising one or more test order(s) defining at least one processing step to be carried out on the biological sample, determining a target laboratory instrument of the analytical laboratory for each of the test order(s) which is configured to carry out the at least one processing step according to the test order, determining whether the target laboratory instrument(s) is ready to carry out the test order, transmitting a readiness command to the target laboratory instrument(s) if the target laboratory instrument(s) is not ready to carry out the test order, the readiness command comprising an instruction which, when executed by the target laboratory instrument, causes the target laboratory instrument to become ready to carry out the test order, executing instructions of the readiness command by the target laboratory instrument in order to cause the target laboratory instrument to become ready to carry out the test order, instructing the target laboratory instrument(s) to process the biological sample according to the test order if the target laboratory instrument is ready to carry out the test order, and processing the biological sample by the target laboratory instrument (s) according to the test order as instructed.

Accordingly, it is a feature of the embodiments of the present disclosure to operate an analytical laboratory such as, an analytical laboratory system in order to provide reduced and/or predicable Turn-Around-Times (TATs) for processing biological samples. Other features of the embodiments of the present disclosure will be apparent in light of the description of the disclosure embodied herein.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates a flowchart illustrating a method of operating an analytical laboratory according to an embodiment of the present disclosure.

FIG. 2 illustrates a flowchart illustrating a method of operating an analytical laboratory comprising a pre-analytical and an analytical laboratory instrument according to an embodiment of the present disclosure.

FIG. 3 illustrates a flowchart illustrating a method of operating an analytical laboratory further comprising a sample transportation system according to an embodiment of the present disclosure.

FIG. 4 illustrates a flowchart illustrating a method comprising a step confirming execution of readiness command by the target instrument(s) according to an embodiment of the present disclosure.

FIG. 5A illustrates a first page of a flowchart illustrating a method of operating an analytical laboratory comprising a plurality of analytical laboratory instruments according to an embodiment of the present disclosure.

FIG. 5B illustrates a second page of a flowchart illustrating a method of operating an analytical laboratory comprising a plurality of analytical laboratory instruments according to an embodiment of the present disclosure.

FIG. 5C illustrates a second page of a flowchart illustrating a method wherein the sample workflow is adapted as a reaction to availability respectively readiness time of an analytical laboratory instrument according to an embodiment of the present disclosure.

FIG. 5D illustrates a second page of a flowchart illustrating a method wherein the readiness of a particular analytical laboratory instrument is delayed in view of processing time of the sample prior to processing by the particular analytical laboratory according to an embodiment of the present disclosure.

FIG. 6 illustrates a flowchart illustrating a method comprising a shutdown of idle analytical instrument(s) according to an embodiment of the present disclosure.

FIG. 7 illustrates a highly schematic block diagram of the analytical laboratory according to an embodiment of the present disclosure.

FIG. 8 illustrates a highly schematic block diagram of a pre-analytical laboratory instrument of the laboratory system according to an embodiment of the present disclosure.

FIG. 9 illustrates a highly schematic block diagram of a pre-analytical laboratory instrument of the laboratory system according to a further embodiment of the present disclosure.

FIG. 10 illustrates a highly schematic block diagram of an analytical laboratory instrument of the laboratory system according to an embodiment of the present disclosure.

FIG. 11 illustrates a highly schematic block diagram of a post-analytical laboratory instrument of the laboratory system according to an embodiment of the present disclosure.

### DETAILED DESCRIPTION

In the following detailed description of the embodiments, reference is made to the accompanying drawings that form a part hereof, and in which are shown by way of illustration, and not by way of limitation, specific embodiments in which the disclosure may be practiced. It is to be understood that other embodiments may be utilized and that logical, mechanical and electrical changes may be made without departing from the spirit and scope of the present disclosure.

Certain terms will be used in this patent application, the formulation of which should not be interpreted to be limited by the specific term chosen, but as to relate to the general concept behind the specific term.

The terms ‘sample’, ‘patient sample’ and ‘biological sample’ can refer to material(s) that may potentially contain an analyte of interest. The patient sample can be derived from any biological source, such as a physiological fluid, including blood, saliva, ocular lens fluid, cerebrospinal fluid, sweat, urine, stool, semen, milk, ascites fluid, mucous, synovial fluid, peritoneal fluid, amniotic fluid, tissue, cultured cells, or the like. The patient sample can be pretreated prior to use, such as preparing plasma from blood, diluting viscous fluids, lysis or the like. Methods of treatment can involve filtration, distillation, concentration, inactivation of interfering components, and the addition of reagents. A patient sample may be used directly as obtained from the source or used following a pretreatment to modify the character of the sample. In some embodiments, an initially solid or semi-solid biological material can be rendered liquid by dissolving or suspending it with a suitable liquid medium. In some embodiments, the sample can be suspected to contain a certain antigen or nucleic acid.

The term ‘analyte’ can be a component of a sample to be analyzed, e.g. molecules of various sizes, ions, proteins, metabolites and the like. Information gathered on an analyte may be used to evaluate the impact of the administration of drugs on the organism or on particular tissues or to make a diagnosis. Thus, ‘analyte’ can be a general term for substances for which information about presence and/or concentration is intended. Examples of analytes are glucose, coagulation parameters, endogenic proteins (e.g., proteins released from the heart muscle), metabolites, nucleic acids, and so on.

The term ‘analysis or ‘analytical test’ as used herein can encompass a laboratory procedure characterizing a parameter of a biological sample for qualitatively assessing or quantitatively measuring the presence or amount or the functional activity of an analyte.

The term ‘reagent’ as used herein can refer to materials necessary for performing an analysis of analytes, including reagents for sample preparation, control reagents, reagents for reacting with the analyte to obtain a detectable signal, and/or reagents necessary for detecting the analyte. Such reagents may include reagents for isolating an analyte and/or reagents for processing a sample and/or reagents for reacting with an analyte to obtain a detectable signal and/or washing reagents and/or diluents.

The term ‘reagent cassette’ as used herein can refer to any vessel/ container comprising a liquid or suspension of reagents. Alternatively, a reagent cassette can be a holder for holding container(s) comprising a liquid or a suspension of reagents.

The term ‘quality control’ or ‘analytical quality control’ can refer to all those processes and procedures designed to ensure that the results of laboratory analysis (analytical tests) are consistent, comparable, accurate and within specified limits of precision.

The term ‘quality control (QC)’ materials as used herein can refer to any composition with known concentration of an analyte, such as positive and negative controls, that can serve the purpose of providing evidence that an analytical test is successfully performed and is giving the expected level of sensitivity and specificity as characterized during technical optimization and validation of the analytical test for diagnostic use. In other words, a ‘quality control’ can be used in the present disclosure as referring to a physical sample used in one or several monitoring processes to monitor the performance of particular tests or assays of an analyzer. Positive controls can primarily monitor calibration of the system and sensitivity. Negative controls can be primarily used to evaluate the specificity of the analytical tests to identify false-positive results.

The terms ‘sample container’ and ‘sample tube’ can refer to any individual container for storing, transporting, and/or processing a sample. In particular, the term without limitation can refer to a piece of laboratory glass- or plastic-ware optionally comprising a cap on its upper end. The container comprising an opening for dispensing/ aspirating liquid into respectively out of the vessel. The opening may be closed by a cap, a breakable seal or like suitable means for closing the opening in a liquid-tight manner. Sample tubes, e.g., sample tubes used to collect blood, can often comprise additional substances such as clot activators or anticoagulant substances which can have an impact on the processing of the sample. As a consequence, different tube types typically can be adapted for pre-analytical and analytical requirements of a particular analysis, e.g., a clinical chemistry analysis, a hematological analysis or a coagulation analysis. A mix up of sample tube types can make (blood) samples unusable for analysis. To prevent errors in the collection and handling of samples, the sample caps of many tube manufacturers can be encoded according to a fixed and uniform color scheme. Some sample tubes types, in addition or alternatively, can be characterized by particular tube dimensions, cap dimensions, and/or tube color. A dimension of a tube can comprise e.g., its height, its size and/or further characteristic shape properties. Sample containers can be identified using identification tag(s) attached thereto.

The term ‘identification tag’ as used herein can refer to an optical and/or radio frequency based identifier that allows the identifier tag to be uniquely identified by a corresponding identification tag reader. The ‘identification tag’ can comprise—but is not limited to—a barcode, a QR code or an RFID tag.

The expression ‘tube type’ can refer to a category of sample tubes which can be characterized by at least one shared property, whereby the shared property can be automatically detected by a lab-device and can thus be used to discriminate a set of sample tubes of a first tube type from another. Some tube types can be designed for carrying samples which can be used for a plurality of different analytical tests. An example for such a tube type can be a serum tube. However, a tube type may also be particular for one single analytical test.

The term ‘sample carrier’ as used herein can refer to any kind of holder configured to receive one or more sample tubes and configured to be used for transporting sample tube(s). Sample carriers may be of two major types, single holders and sample racks.

A ‘single holder’ can be a type of sample carrier configured to receive and transport a single sample tube. Typically, a single holder can be provided as a puck, i.e., a flat cylindrical object with an opening to receive and retain a single sample tube.

A ‘sample rack’ can be a type of sample carrier, typically made of plastics and/or metal, adapted for receiving, holding and transporting sample tubes, e.g., five or more sample tubes, e.g., disposed in one or more rows. Apertures, windows or slits may be present to enable visual or optical inspection or reading of the sample tubes or of the samples in the sample tubes or of a label, such as a barcode, present on the sample tubes held in the sample rack.

The term ‘laboratory instrument’ as used herein can encompass any apparatus or apparatus component operable to execute one or more processing steps/workflow steps on one or more biological samples and/or one or more reagents. The expression ‘processing steps’ thereby can refer to physically executed processing steps such as centrifugation, aliquotation, sample analysis and the like. The term ‘instrument’ can cover pre-analytical instruments, post-analytical instruments, and also analytical instruments.

The term ‘analyzer’/‘analytical instrument’ as used herein can encompass any apparatus or apparatus component configured to obtain a measurement value. An analyzer can be operable to determine via various chemical, biological, physical, optical or other technical procedures a parameter value of the sample or a component thereof. An analyzer may be operable to measure the parameter of the sample or of at least one analyte and return the obtained measurement value. The list of possible analysis results returned by the analyzer can comprise, without limitation, concentrations of the analyte in the sample, a digital (yes or no) result indicating the existence of the analyte in the sample (corresponding to a concentration above the detection level), optical parameters, DNA or RNA sequences, data obtained from mass spectrometry of proteins or metabolites and physical or chemical parameters of various types. An analytical instrument may comprise units assisting with the pipetting, dosing, and mixing of samples and/or reagents. The analyzer may comprise a reagent holding unit for holding reagents to perform the assays. Reagents may be arranged for example in the form of containers or cassettes containing individual reagents or group of reagents, placed in appropriate receptacles or positions within a storage compartment or conveyor. It may comprise a consumable feeding unit. The analyzer may comprise a process and detection system whose workflow can be optimized for certain types of analysis. Examples of such analyzer are clinical chemistry analyzers, coagulation chemistry analyzers, immunochemistry analyzers, urine analyzers, nucleic acid analyzers, used to detect the result of chemical or biological reactions or to monitor the progress of chemical or biological reactions.

The term ‘pre-analytical instrument’ as used herein can encompass any apparatus or apparatus component that is configured to perform one or more pre-analytical processing steps/workflow steps comprising—but not limited to—centrifugation, resuspension (e.g., by mixing or vortexing), capping, decapping, recapping, sorting, tube type identification, sample quality determination and/or aliquotation steps. The processing steps may also comprise adding chemicals or buffers to a sample, concentrating a sample, incubating a sample, and the like.

The term ‘post-analytical instrument’ as used herein can encompass any apparatus or apparatus component that can be configured to perform one or more post-analytical processing steps/workflow steps comprising—but not limited to—sample unloading, transport, recapping, decapping, temporary storage/buffering, archiving (refrigerated or not), retrieval and/or disposal.

The term ‘sample transportation system’ as used herein can encompass any apparatus or apparatus component that can be configured to transport sample carriers (each holding one or more sample containers) between laboratory instruments. In particular, the sample transportation system can be a one dimensional conveyor-belt based system, a two-dimensional transportation system (such as a magnetic sample carrier transport system) or a combination thereof.

The term ‘control unit’ as used herein can encompass any physical or virtual processing device configurable to control a laboratory instrument or system comprising one or more laboratory instruments in a way that workflow(s) and workflow step(s) can be conducted by the laboratory instrument/system. The control unit may, for example, instruct the laboratory instrument/system to conduct pre-analytical, post analytical and analytical workflow(s)/workflow step(s). The control unit may receive information from a data management unit regarding which steps need to be performed with a certain sample. In some embodiments, the control unit may be integral with a data management unit, may be comprised by a server computer and/or be part of one laboratory instrument or even distributed across multiple instruments of the analytical laboratory. The control unit may, for instance, be embodied as a programmable logic controller running a computer-readable program provided with instructions to perform operations.

A ‘data management unit’ or ‘database’ can be a computing unit for storing and managing data. This may involve data relating to biological sample(s) to be processed by the automated system. The data management unit may be connected to an LIS (laboratory information system) and/or an HIS (hospital information system). The data management unit can be a unit within or co-located with a laboratory instrument. It may be part of the control unit. Alternatively, the database may be a unit remotely locater. For instance, it may be embodied in a computer connected via a communication network.

The term ‘server’ as used herein can encompass any physical machine or virtual machine having a physical or virtual processor, capable of accepting requests from and giving responses accordingly. It can be clear to a person of ordinary skill in the art of computer programming that the term machine may refer to a physical hardware itself, or to a virtual machine such as a JAVA Virtual Machine (JVM), or even to separate virtual machines running different Operating Systems on the same physical machine and sharing that machine's computing resources. Servers can run on any computer including dedicated computers, which individually can also be often referred to as ‘the server’ or shared resources such as virtual servers. In many cases, a computer can provide several services and have several servers running. Therefore, the term server can encompass any computerized device that shares a resource with one or more client processes.

The term ‘communication network’ as used herein can encompass any type of wireless network, such as a WiFi™, GSM™, UMTS or other wireless digital network or a cable based network, such as Ethernet™ or the like. In particular, the communication network can implement the Internet protocol (IP). For example, the communication network can comprise a combination of cable-based and wireless networks.

The term ‘user interface’ as used herein can encompass any suitable piece of software and/or hardware for interactions between an operator and a machine, including but not limited to a graphical user interface (GUI) for receiving as input a command from an operator and also to provide feedback and convey information thereto. Also, a system/device may expose several user interfaces to serve different kinds of users/operators.

An ‘analytical laboratory’ as used herein can comprise a control unit operatively coupled to one or more analytical; pre- and post-analytical work cells wherein the control unit can be operable to control the instruments. In addition, the control unit may be operable to evaluate and/or process gathered analysis data, to control the loading, storing and/or unloading of samples to and/or from any one of the analyzers, to initialize an analysis or hardware or software operations of the analysis system used for preparing the samples, sample tubes or reagents for said analysis and the like. In particular, the instruments of an analytical laboratory and the control unit can be interconnected by a communication network.

A ‘test order’ as used herein can encompass any data object, computer loadable data structure, modulated data representing such data being indicative of one or more processing steps to be executed on a particular biological sample. For example, a test order may be a file or an entry in a database. A test order can indicate an analytical test if, for example, the test order can comprise or can be stored in association with an identifier of an analytical test to be executed on a particular sample.

A ‘STAT sample’ can be a sample which needs to be processed and analyzed very urgently as the analysis result may be of life-crucial importance for a patient.

The term ‘workflow’ as used herein can refer to a collection of workflow steps/processing steps. According to particular embodiments, the workflow can define a sequence in which the processing steps can be carried out.

The term ‘workflow step’ as used herein can encompass any activity belonging to a workflow. The activity can be of an elementary or complex nature and can be typically performed at or by one or more work cell(s).

It has observed that delays can be caused by the laboratory instruments not being ready to process the biological sample at the time the sample is loaded into them.

Embodiments herein disclosed can address the above-identified need by a method of operating an analytical laboratory. The method can comprise receiving and identifying a biological sample by a pre-analytical laboratory instrument of the analytical laboratory, retrieving an order list from a database, the order list comprising one or more test order(s) defining at least one processing step to be carried out on the biological sample, determining a target laboratory instrument of the analytical laboratory for each of the test order(s) which is configured to carry out the at least one processing step according to the test order, determining whether the target laboratory instrument(s) is ready to carry out the test order, transmitting a readiness command to the target laboratory instrument(s) if the target laboratory instrument(s) is not ready to carry out the test order, the readiness command comprising an instruction which, when executed by the target laboratory instrument, causes the target laboratory instrument to become ready to carry out the test order, executing instructions of the readiness command by the target laboratory instrument in order to cause the target laboratory instrument to become ready to carry out the test order, instructing the target laboratory instrument(s) to process the biological sample according to the test order if the target laboratory instrument is ready to carry out the test order, and processing the biological sample by the target laboratory instrument (s) according to the test order as instructed.

In order to save on running costs such as, for example, electricity, laboratory instruments or certain units thereof can switch into low power modes such as, for example, stand-by or hibernation modes, or even completely shut down when not in use. However, waking up the laboratory instruments from such low power modes can take considerable amount of time. It has been observed that as a consequence, processing of a biological sample by a laboratory instrument(s) which is in a low power mode can often be delayed as the biological sample can be waiting idly during the readiness time of the laboratory instrument. Such occurrences can lead to increased and unpredictable Turn-Around-Times (TAT).

In order to avoid biological samples having to sit idle while laboratory instrument(s) wake up from low power modes, according to embodiments disclosed herein, it can be determined whether the instrument is powered on and not in a low-power mode. If the instrument is not powered on or in a low-power mode, a readiness command can be sent to analytical instruments as soon as the biological sample has been identified and the corresponding test order(s) retrieved. The readiness command can comprise instructions which, when executed by the target laboratory instrument, can cause the powering on or waking up of the target laboratory instrument from a low-power mode.

Besides instruments entering low power modes of operation, unavailability of all modules of the target instrument required to carry out the respective test order can also lead to delays. There can be multiple causes for modules of a target laboratory instrument to not to be operational, such as maintenance activates. To avoid delays caused by modules of the target laboratory instrument not being operational, according to embodiments disclosed herein, if one or more consumables required to carry out the respective test order are not available to the target laboratory instrument, a readiness command can be sent to analytical instruments. The readiness command can comprise instructions which, when executed by the target laboratory instrument, can cause all modules of the analytical instrument required to carry out the respective test order to be brought into operational state. According to embodiments disclosed herein, modules can be made operational by interrupting or finalizing maintenance activities of the respective module. Alternatively, or additionally, according to further embodiments disclosed herein, modules of the target instrument can be made operational by heating up of an incubation module or cooling down of a refrigeration module of the target instrument.

In a further scenario, unavailability of consumables required to carry out the respective test order can lead to delays in processing of the biological sample. To avoid delays caused by consumables required to carry out the respective test order not being available, according to embodiments disclosed herein, it can be determined whether all consumables required to carry out the respective test order are available. Corresponding, if one or more consumables required to carry out the respective test order are not available to the target laboratory instrument, a readiness command can be sent to analytical instruments as soon as the biological sample has been identified and the corresponding test order(s) retrieved. The readiness command can comprise instructions which, when executed by the target laboratory instrument, can cause all consumables required to carry out the respective test order to be made available to the target laboratory instrument. According to embodiments disclosed herein, consumables can be made available to the target laboratory instrument by loading such as, for example, automatic loading, the required consumable(s) from a storage location, such as a refrigerated storage unit. Alternatively, or additionally, according to further embodiments disclosed herein, consumable(s) can be made available by carrying out consumable preparation steps, such as reconstitution of lyophilized reagents (i.e., freeze drying the liquid reagent which removes the liquid component and leaves a dry powder behind).

In an even further scenario, expired and/or out of range quality control and/or calibration values can lead to delays in processing of the biological sample, since such quality control and/or calibration processes take a certain amount of time and only thereafter can the biological sample be processed. To avoid delays caused by out of range quality control and/or calibration values, according to embodiments disclosed herein, if one or more quality control and/or calibration values are out of range or expired, a readiness command can be sent to analytical instruments. The readiness command can comprise instructions which, when executed by the target laboratory instrument, can cause carrying out of quality control and/or calibration steps to ensure all quality control and/or calibration values of the target laboratory instrument are up-to-date and valid.

According to further embodiments disclosed herein, the readiness command to the analytical instrument(s) can be timed such that the analytical instrument(s) becomes ready/ready just by the time the biological sample needs to be processed by the respective analytical instrument. This feature can be referred to as just-in-time availability of the laboratory instruments.

According to even further embodiments disclosed herein, a readiness response from the target laboratory instruments can be evaluated and an alternative analytical instrument can be determined if the readiness response indicates that the target laboratory instrument is unable to become ready to process the biological sample according to the corresponding test order.

According to even further embodiments disclosed herein, the order of processing of a plurality of test orders corresponding to a biological sample can be dynamically adjusted as a reaction to readiness responses from the analytical instruments to ensure fastest Turn-Around-Times (TAT) and/or most intensive use of low power modes of the instruments.

Embodiments disclosed herein can be advantageous as they can allow a significant reduction of Turn-Around-Times (TAT) of processing biological samples. The disclosed method/system can be proactive by sending a readiness command to instruments that have to process the biological sample based on test order(s) as compared to known methods/laboratory systems which can, at best, be reactive by getting instruments ready only as a response to an incoming biological sample.

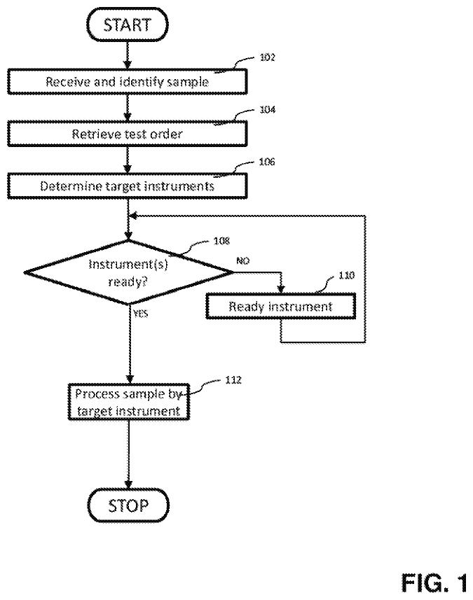

Referring initially to FIG. 1, FIG. 1 shows a flowchart illustrating a first embodiment of a herein disclosed method of operating an analytical laboratory. According to the method disclosed, in a first step 102, biological sample(s) can be received and identified by a pre-analytical laboratory instrument of the analytical laboratory. The identification can be performed, in one embodiment, by an identifier tag reader reading an identifier tag attached to a sample container holding the biological sample.

In a subsequent step 104, an order list can be retrieved from a database. The order list can comprise one or more test order(s) defining at least one processing step to be carried out on the biological sample. Thereafter, in a step 106, a target laboratory instrument of the analytical laboratory can be determined for each of the test order(s). In this determination, an analytical instrument can be selected which can be configured to carry out the at least one processing step according to the test order.

Once the target laboratory instrument has been determined, in a step 108, its availability can be determined such as, for example, whether the target laboratory instrument(s) is ready/ready to carry out the test order. Such may be based on a continuous inventory of laboratory resources and/or based on a query of the target laboratory instrument(s). The terms ‘ready’ or ‘available’—in the context of the present disclosure—can be understood to comprises one or more of the following:
The analytical instrument is switched on and not in a low power mode;
All modules of the analytical instrument required to carry out the respective test order are operational;
All consumables required to carry out the respective test order are available; and/or
All quality control and/or calibration steps required before carrying out the respective test order are available are up-to-date and valid.

If it has been determined (in step 108) that the target laboratory instrument is not ready to carry out the test order, in a subsequent step 110, a readiness command can be transmitted to the target laboratory instrument(s). The readiness command can comprise an instruction which, when executed by the target laboratory instrument, can cause the target laboratory instrument to become ready to carry out the test order. Upon receipt of the readiness command, still part of step 110, the target laboratory instrument can execute the instruction(s) comprised therein in order to cause the target laboratory instrument to become ready to carry out the test order. Corresponding to the listing of the preceding paragraph, such can include:
Waking up the analytical instrument from a low power mode;
Ensuring all modules of the analytical instrument required to carry out the respective test order are operational;
Making all consumables required to carry out the respective test order available; and/or
Performing all quality control and/or calibration steps required before carrying out the respective test order.

After the readiness of the target laboratory instrument to carry out the test order has been verified, in step 112, the target laboratory instrument can be instructed to process the biological sample according to the test order. Still part of step 112, the target laboratory instrument(s) can process the biological sample according to the test order as instructed.

According to embodiments disclosed herein, the readiness command to the target laboratory instrument(s) can be generated considering a readiness time of the target laboratory instrument to ensure it can be ready to process the biological sample without delays. Corresponding to the broad interpretation of the term ‘readiness’, the term ‘readiness time’ can be interpreted to include the amount of time required to carry out all activities covered by the process to make the instrument ready (such as, for example, wake-up from low power modes, ensuring all required modules are operational, performing quality control/calibration steps if needed, and the like).

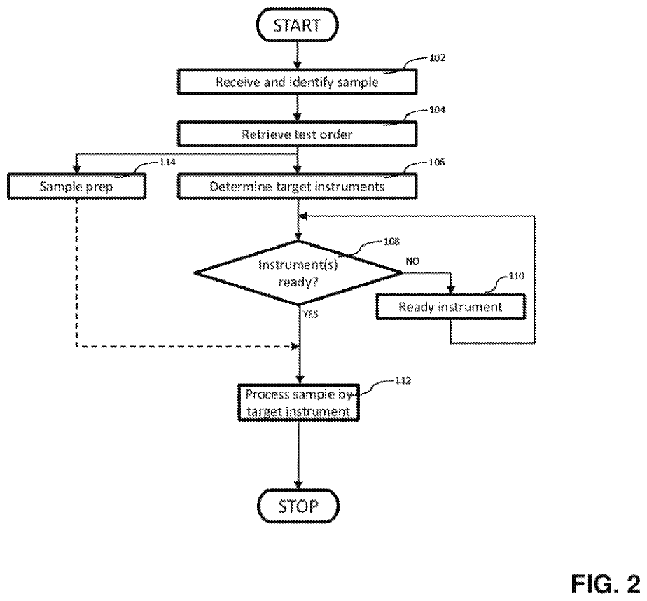

Turning now to FIG. 2, a further embodiment of a herein disclosed method of operating an analytical laboratory will be described. As illustrated on the flowchart of this figure, in a step 114, the biological sample can be processed by a pre-analytical laboratory instrument (also referred to as sample prep.). According to embodiments disclosed herein, and as illustrated in FIG. 2, the readiness command to the target laboratory instrument(s) can be generated further considering a processing time of the biological sample by the pre-analytical laboratory instrument. The processing time can relate to the time required to carry out the sample preparatory steps (such as centrifugation, resuspension such as, for example, by mixing or vortexing, capping, decapping, recapping, sorting, tube type identification, sample quality determination and/or aliquotation) required to be performed before the biological sample can be processed by the target laboratory instrument(s).

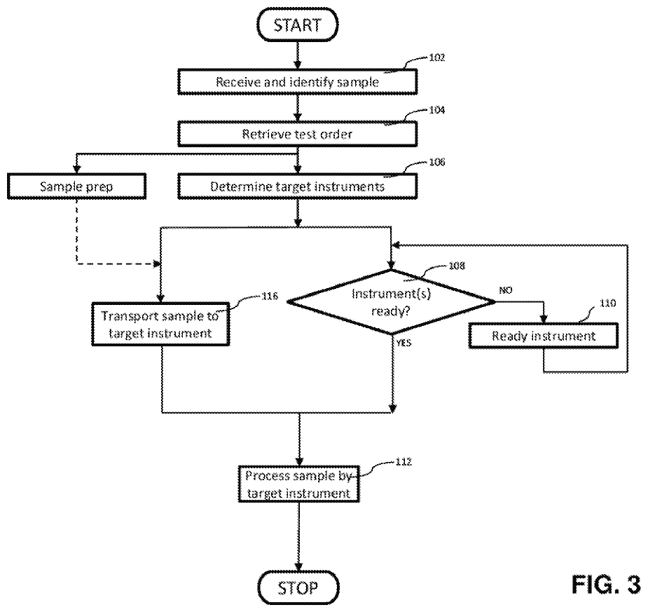

FIG. 3 shows a flowchart of a further embodiment of a herein disclosed method of operating an analytical laboratory which, in addition to a pre-analytical laboratory instrument for sample preparation, can further comprise a sample transportation system at least for transporting the biological sample from the pre-analytical laboratory instrument to the analytical instrument. According to embodiments disclosed herein and as illustrated in FIG. 3, the readiness command to the target laboratory instrument(s) can be generated further considering a transportation time of the biological sample from the pre-analytical laboratory instrument to the target laboratory instrument by a sample transportation system of the analytical laboratory.

All-in-all, the timing and generation of the readiness command, taking the above parameters in consideration, can be aimed at ensuring that the target laboratory instrument becomes ready by the time the biological sample is processed by the pre-analytical laboratory instrument and/or has been transported to the target laboratory instrument by a sample transportation system. In this way a just-in-time availability of the analytical instruments can be ensured to maximize the use of low-power modes thereof while avoiding delays in the processing of the biological samples and hence of the analytical results obtained.

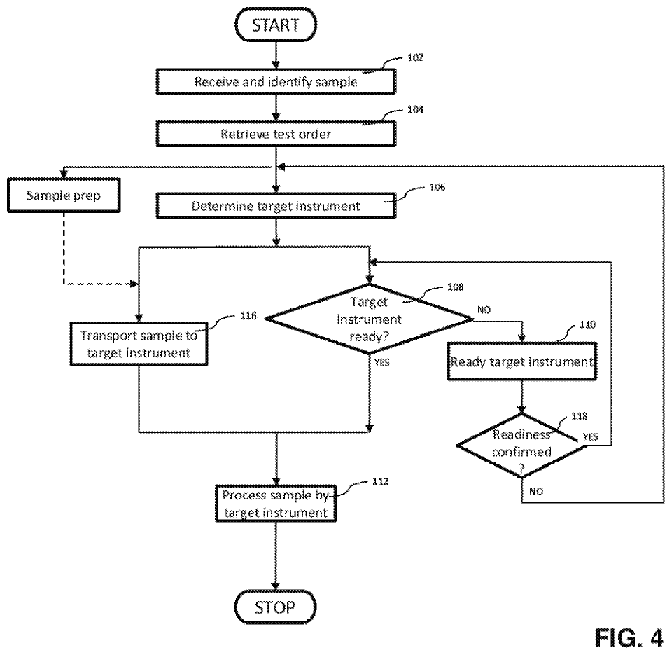

In order to provide an additional layer of certainty to the Turn-Around-Time (TAT) and to potentially avoid unnecessary delays, embodiments disclosed herein such as shown on FIG. 4 can comprise a check (using command-response) whether the target instrument is actually able to become ready to perform the test order on the biological sample. The readiness confirmation, step 118, can comprise two substeps. In a first substep, the target laboratory instrument can transmit a readiness response. The readiness response can be indicative of whether the target laboratory instrument is able to execute the readiness command. According to further embodiments disclosed herein, the readiness response can further comprise a readiness complete time indicative of the time forecast to be required for the analytical instrument to become ready to process the biological sample according to the respective test order. In a second substep, if the readiness response by the target laboratory instrument indicates that the target laboratory instrument is not able to execute the readiness command, an alternative target laboratory instrument can be searched for. The search for an alternative target laboratory instrument can be performed by repeating steps 106 through 110 until an alternative target laboratory instrument is determined which can be confirms by a readiness response that it is able to execute the readiness command.

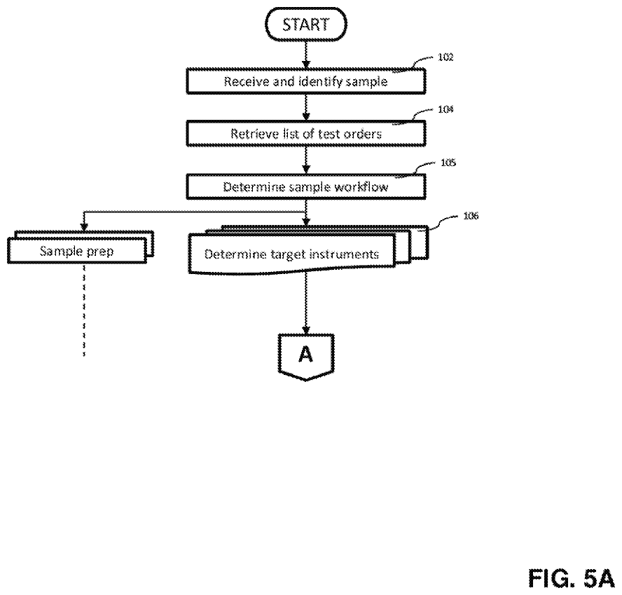

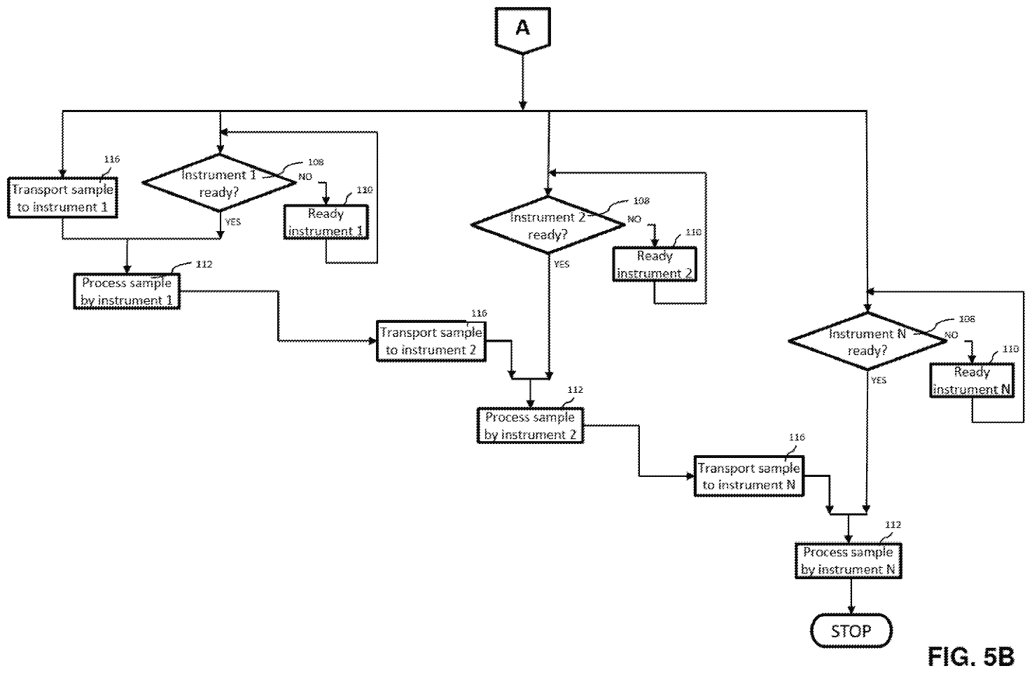

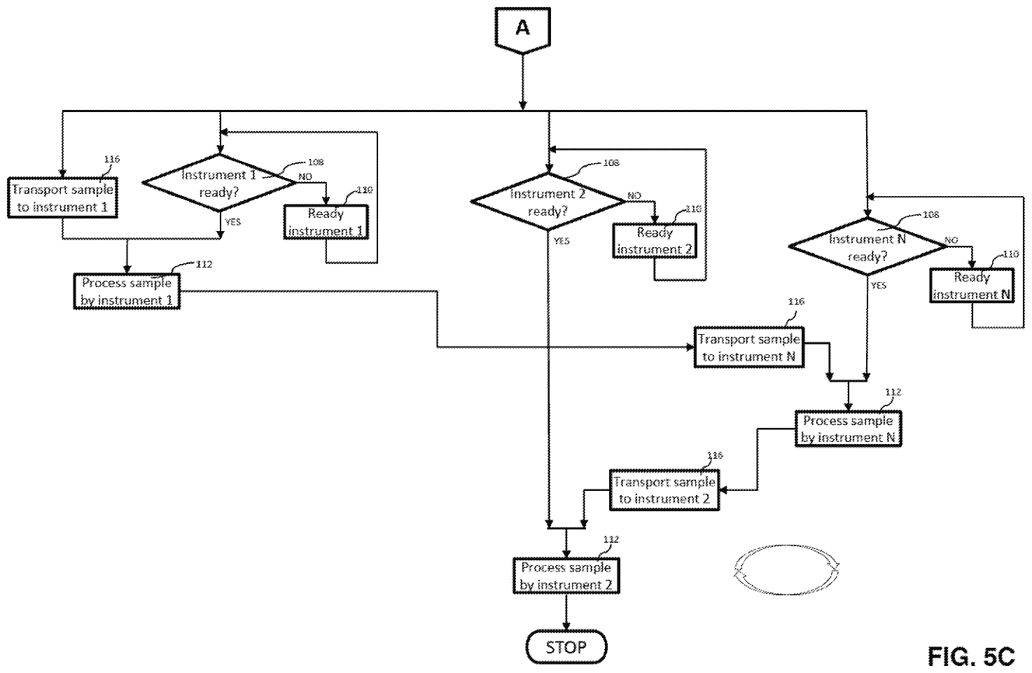

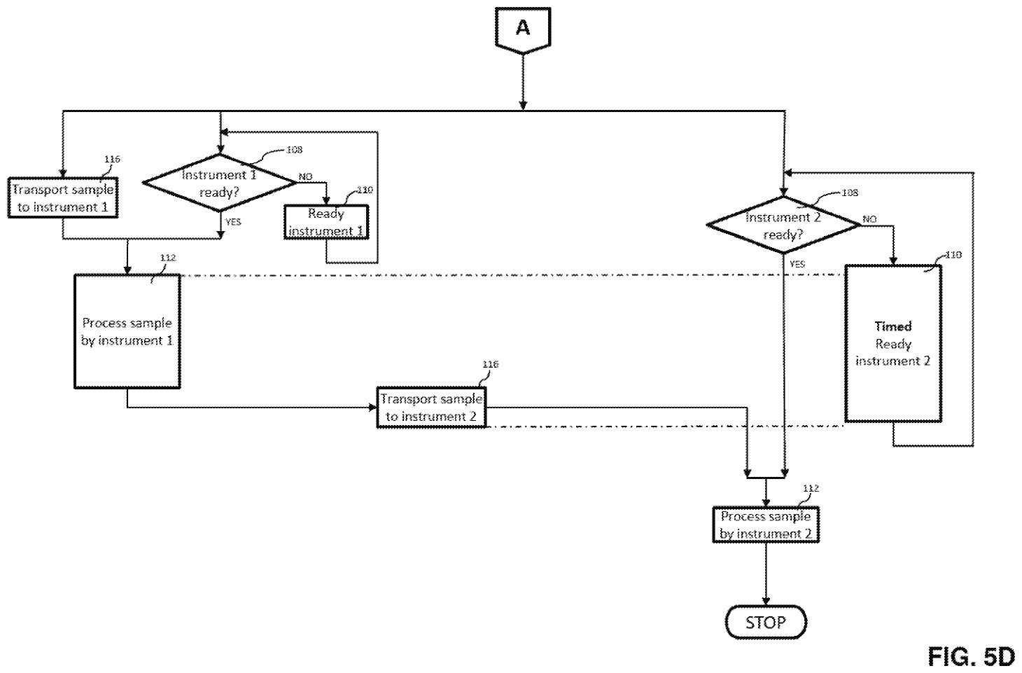

Embodiments of the disclosed method/system will be described with reference to FIGS. 5A-D which can comprise a plurality of laboratory instruments and the order list corresponding to a biological sample comprising a plurality of test orders.

FIG. 5A shows the first page of a flowchart illustrating a first embodiment of a herein disclosed method of operating an analytical laboratory comprising a plurality of laboratory instruments. In addition to the steps already described with reference to the previous figures, FIG. 5A shows step 105 of determining a sample workflow for processing the biological sample comprising a sequence of workflow steps corresponding to each test order of the order list. According to embodiments of the disclosed method/system, the sample workflow can define one or more of:
A number n of aliquots to be prepared from the biological sample—The number n can define into how many portions the biological sample can be divided, such portions being referred to as aliquots of the biological sample. The biological sample as received can then be referred to as primary sample. Depending on the test orders, the number of aliquots may be even zero, in other words, no aliquots are created and all processing steps of all targets can be performed on the primary sample. Such workflow can also be referred to as aliquotless workflow.
Allocation of an aliquot or primary sample to each target—Once the required number n of aliquots has been determined (and can be zero as mentioned above), an aliquot or the primary sample can be allocated to each target for performing the one or more processing steps at the target.
Sequence in which the targets are to be processed—The target processing sequence can define the order in which the biological sample can be processed by the targets. The sequence can be of great importance especially when the same aliquot or primary sample is processed by more than one laboratory instruments of different sensitivity and/or contamination risk.
Timing of processing of the targets—According to embodiments of the disclosed method/ system, in addition to the processing sequence, the timing according to which the biological sample or aliquots thereof are processed can also be defined by the sample workflow. For example, the timing is of great importance if the biological sample first needs to be prepared by a pre-analytical instrument and must be processed by an analytical instrument immediately thereafter. Another example can be when the biological sample needs to spend a very specific amount of time in a pre-analytical instrument such as an incubator or centrifuge to ensure proper sample preparation for an analytical instrument. Furthermore, the timing of the processing of the targets can also be relevant in view of sample degradation which can often be correlated with its processing time, especially when the sample is outside of a temperature controlled area, in which case the sample can be transferred to a post-analytical instrument such as a temperature—controlled archiving unit after a certain amount of time. Another example can be when certain processing steps such as, for example, rarely performed analytical tests that are performed relatively rarely in an analytical laboratory. In such cases, embodiments of the disclosed method/system align the timing of processing of the targets with a schedule of tests performed by the analytical laboratory in order to avoid that the respective target cannot be performed for an extended period of time. Timing of processing of the targets can also be of great importance in view of the validity of quality control and/or calibration of certain laboratory instruments such as, for example, analytical instruments.

Once the sample workflow is determined, in a subsequent step 106, target instruments can be determined for each of the test order(s) which can be configured to carry out the at least one processing step according to the test order. Thereafter, a plurality of readiness commands can be generated for each target laboratory instrument, wherein each readiness command can be for a particular target laboratory instrument.

In order to ensure just-in-time availability of the instruments, each readiness command for a particular target laboratory instrument can be determined considering:
a sum of transportation time of the biological sample from the pre-analytical laboratory instrument to each target laboratory instrument; and
a sum of processing time of the biological sample by the pre-analytical laboratory instrument and each target laboratory instrument preceding the particular target laboratory instrument in the sample workflow.

FIG. 5B shows the second page of a flowchart illustrating the timing of the readiness command to the plurality of analytical laboratory instruments, such timing being in sync with the transport time and processing time of the biological sample by instruments respectively transportation system.

According to embodiments disclosed herein, the readiness response by the target laboratory instruments can comprise an indication of an estimated time of availability of when the target laboratory instrument will become ready to carry out the respective test order.

FIG. 5C shows the second page of a flowchart illustrating embodiments of a herein disclosed method wherein the sample workflow is adapted as a reaction to the readiness or a readiness time of a target laboratory instrument. In particular, FIG. 5 illustrates how the sample workflow for processing the biological sample can be re-determined by postponing processing of the biological sample by a first target laboratory instrument if a second target laboratory instrument will become ready earlier to carry out its corresponding test order. It can be noted that such re-determination of the sample workflow can be possible if further constraints on the order of processing are not violated (e.g., cross-contamination risks from a less sensitive instrument followed by a more sensitive analytical test).

FIG. 5D shows the second page of a flowchart illustrating embodiments of a herein disclosed method wherein the readying of a particular target laboratory instrument is delayed in view of processing time of the sample prior to processing by the particular analytical laboratory. Alternatively, or additionally, the readiness command can be transmitted to the analytical instrument as soon as generated and, at the same time, the readiness command can comprise a delay time or readiness time.

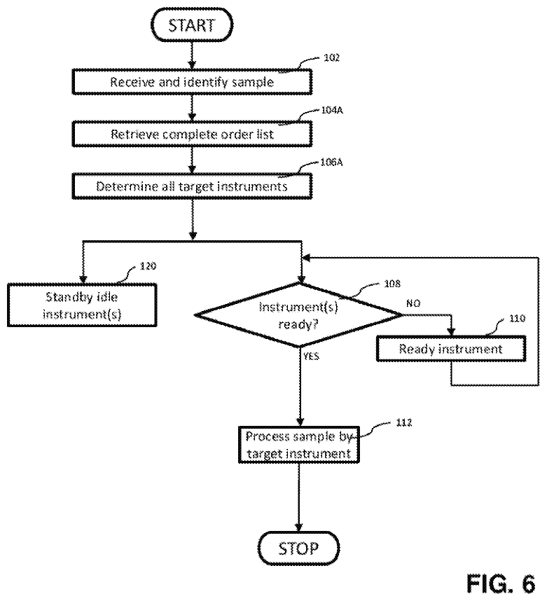

Turning now to FIG. 6, further embodiments of the disclosed method are described which—in addition to readying instruments on-demand—can also comprise steps aimed at instructing laboratory instruments to switch into a low-power mode. In order to achieve this aim, in a step 104A, a complete order list can be retrieved from a database. The complete order list can comprise all test order(s) registered in the database that have not been completed. It can be emphasized that the complete order list can comprise orders for all samples and not only the orders corresponding to the sample received and identified in step 102. In a subsequent step 106A, a target laboratory instrument of the analytical laboratory which is configured to carry out the at least one processing step according to the test order can be identified for each of the test order(s) of the complete order list. Thereafter, in a step 110, a standby command can be transmitted to any analytical instrument of the analytical laboratory not identified as target laboratory instrument for any of the test order(s) of the complete order list. In response to the standby command, analytical instrument(s) can switch into a low power mode. Low power mode can comprise any operational mode of an instrument which can save a resource such as, for example, electricity or consumable(s), including but not limited to stand-by or hibernation modes or even complete shutdown.

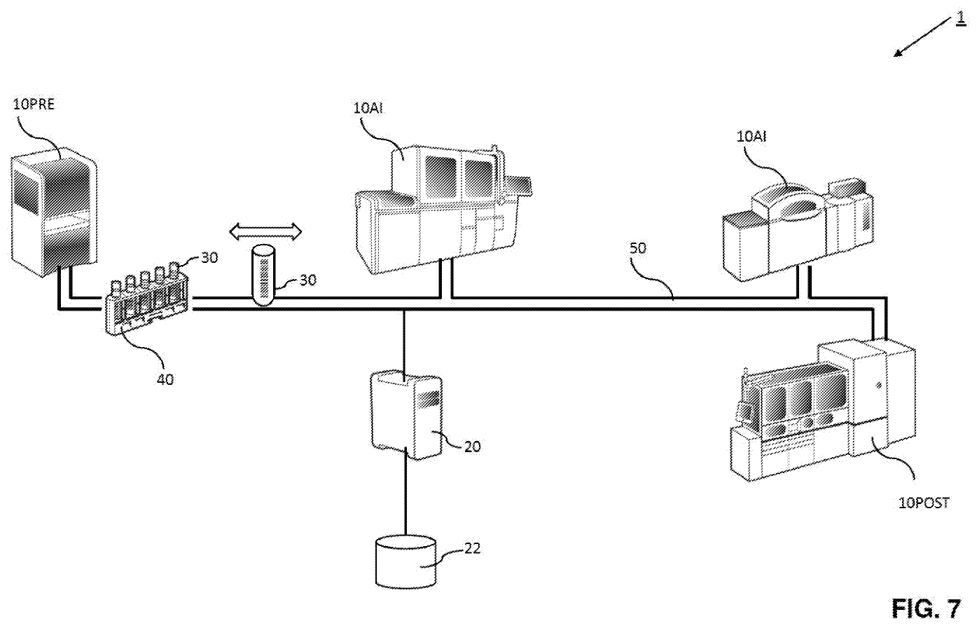

FIG. 7 shows a highly schematic block diagram of an embodiment of the disclosed analytical laboratory 1. As shown on the block diagram of FIG. 7, embodiments of the disclosed analytical laboratory 1 for processing biological sample(s) can comprise a plurality of laboratory instruments 10, 10PRE, 10LD, 10AI, 10PA and a control unit 20 communicatively connected by a communication network. The plurality of laboratory instruments 10, 10PRE, 10LD, 10AI, 10PA can be configured to execute processing steps on the biological samples according to instructions from the control unit 20.

The pre-analytical instruments 10PRE comprised by the analytical laboratory 1 may be one or more from the list comprising: an instrument for centrifugation of samples, a capping-, decapping- or recapping instrument, aliquoter, a buffer to temporarily store biological samples or aliquots thereof.

The post-analytical instruments 10POST comprised by the analytical laboratory 1 may be one or more from the list comprising: a recapper, an unloader for unloading a sample from an analytical system and/or transporting the sample to a storage unit or to a unit for collecting biological waste.

According to various embodiments of the disclosed analytical laboratory 1, the plurality of laboratory instruments 10, 10PRE, 10LD, 10AI, 10PA may be identical or different instruments such as clinical- & immunochemistry analyzers, coagulation chemistry analyzers, immunochemistry analyzers, urine analyzers, nucleic acid analyzers, hematology instruments, and the like.

The control unit 20 can be configured to control the laboratory system 1 to carry out the steps of one or more of the methods herein disclosed.

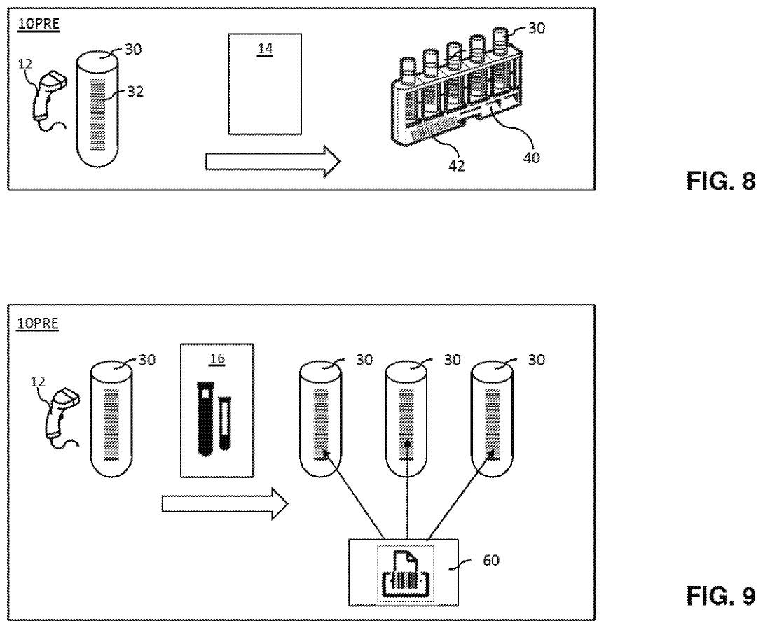

Turning now to FIGS. 8 through 11, particular embodiments of the laboratory instruments 10PRE, 10POST, 10AI are described.

FIG. 8 shows a pre-analytical laboratory instrument 10PRE comprising a sample container sorting unit 14 configured to sort sample containers 30 holding biological samples into sample carriers 40, each sample carrier 40 being identified by a carrier identifier (Carrier-ID) of a carrier tag 42 attached to the sample carrier 40. The pre-analytical laboratory instruments 10PRE can be further configured to transmit signals to the laboratory control unit associating the sample identifier(s) ID of sorted sample containers 30 with the sample carrier identifier(s) Carrier-ID of the corresponding sample carrier(s) 40. For embodiments where a pre-analytical laboratory instrument 10PRE sorts sample containers 30 into sample carriers 40, one or more analytical laboratory instruments can further be configured to read the carrier identifier Carrier-ID from the carrier tag 42 and transmit the carrier identifier Carrier-ID to the laboratory control unit with the test query.

FIG. 9 shows a further embodiment of a pre-analytical laboratory instrument 10PRE, comprising an aliquoting unit 16 configured to prepare aliquots of biological sample(s) from the sample container(s) 30 and provide each of the aliquots with a sample identifier ID on an identifier tag 32 by an identifier tag writer 60.

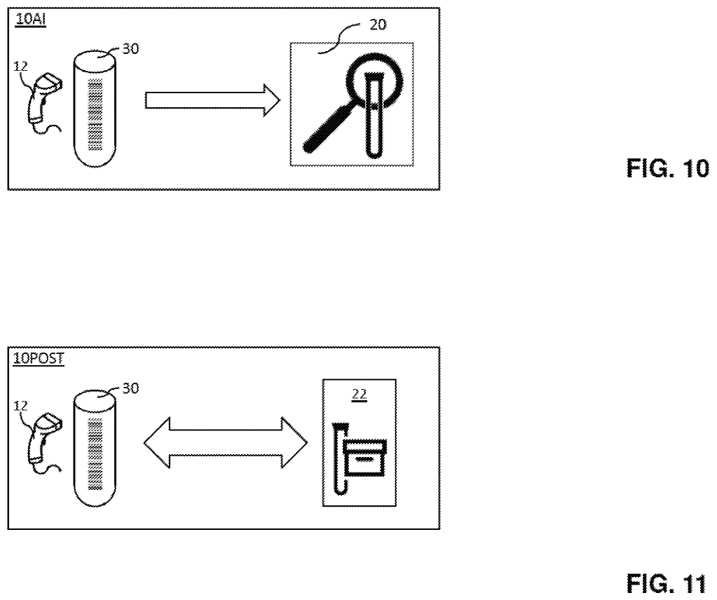

FIG. 10 shows an embodiment of an analytical laboratory instrument 10AI, comprising an analytical unit 18 configured to carry out an analytical test to measure the presence and/or concentration of at least one analyte in the biological sample. The analytical laboratory instrument 10AI can perform analytical test(s) of the biological sample in response to the test order(s).

FIG. 11 shows an embodiment of a post-analytical laboratory instrument 10POST comprising a storage unit 19. The post-analytical laboratory instrument 10AI can be configured to store respectively retrieve sample containers 30 into respectively from the storage unit 19. The query by post-analytical laboratory instrument(s) 10POST to the laboratory control unit for a processing order can comprise a container to store respectively retrieve into respectively from the storage unit 19. Correspondingly, when queried by a post-analytical laboratory instrument 10POST, the control unit can transmit data indicative of a sample container 30 to be retrieved from the storage unit 19. In response to the data indicative of a sample container 30 to be stored respectively retrieved, the post-analytical laboratory instrument 10POST can store and/or retrieve the sample container 30 from the storage unit 19.

Further disclosed and proposed is a computer program product including computer-executable instructions for performing the disclosed method in one or more of the embodiments enclosed herein when the program is executed on a computer or computer network. Specifically, the computer program may be stored on a computer-readable data carrier or a server computer. Thus, specifically, one, more than one or even all of method steps as indicated above may be performed by using a computer or a computer network, preferably by using a computer program.

As used herein, a computer program product can refer to the program as a tradable product. The product may generally exist in any format, such as in a downloadable file, on a computer-readable data carrier on premise or located at a remote location (cloud). Specifically, the computer program product may be distributed over a data network (such as a cloud environment). Furthermore, not only the computer program product, but also the execution hardware may be located on-premise or in a cloud environment.

Further disclosed and proposed can be a computer-readable medium comprising instructions which, when executed by a computer system, can cause an analytical laboratory to perform the method according to one or more of the embodiments disclosed herein.

Further disclosed and proposed can be a modulated data signal comprising instructions which, when executed by a computer system, can cause an analytical laboratory to perform the method according to one or more of the embodiments disclosed herein.

It is noted that terms like “preferably,” “commonly,” and “typically” are not utilized herein to limit the scope of the claimed embodiments or to imply that certain features are critical, essential, or even important to the structure or function of the claimed embodiments. Rather, these terms are merely intended to highlight alternative or additional features that may or may not be utilized in a particular embodiment of the present disclosure.

Having described the present disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

We claim:

1. A method of operating an analytical laboratory, the method comprising:
a) receiving and identifying a biological sample by a pre-analytical laboratory instrument of the analytical laboratory;
b) retrieving an order list from a database, the order list comprising one or more test order(s) defining at least one processing step to be carried out on the biological sample;
c) determining a target laboratory instrument of the analytical laboratory for each of the test order(s) which is configured to carry out the at least one processing step according to the test order;
d) determining whether the target laboratory instrument(s) is ready to carry out the test order;
e) transmitting a readiness command to the target laboratory instrument(s) if the target laboratory instrument(s) is not ready to carry out the test order, the readiness command comprising an instruction which, when executed by the target laboratory instrument, causes the target laboratory instrument to become ready to carry out the test order;
f) executing instructions of the readiness command by the target laboratory instrument in order to cause the target laboratory instrument to become ready to carry out the test order;
g) instructing the target laboratory instrument(s) to process the biological sample according to the test order if the target laboratory instrument is ready to carry out the test order; and
h) processing the biological sample by the target laboratory instrument (s) according to the test order as instructed.

2. The method of operating an analytical laboratory according to claim 1, wherein the readiness command is generated by considering a processing time of the biological sample by the pre-analytical laboratory instrument and/or a transportation time of the biological sample from the pre-analytical laboratory instrument to the target laboratory instrument by a sample transportation system of the analytical laboratory and/or a readiness time of the target laboratory instrument such that the target laboratory instrument becomes ready by the time the biological sample is processed by the pre-analytical laboratory instrument and/or has been transported to the target laboratory instrument by a sample transportation system.

3. The method of operating an analytical laboratory according to claim 1, further comprising,
e′) transmitting a readiness response by the target laboratory instrument, the readiness response being indicative of whether the target laboratory instrument is able to execute the readiness command; and
e″) if the readiness response by the target laboratory instrument indicates that the target laboratory instrument is not able to execute the readiness command, repeating steps c) through e) until an alternative target laboratory instrument is determined which confirms by a readiness response that the target laboratory instrument is able to execute the readiness command.

4. The method of operating an analytical laboratory according to claim 1, wherein the order list comprises a plurality of test orders, each test order defining at least one processing step to be carried out on the biological sample, the method further comprising,
determining a sample workflow for processing the biological sample comprising a sequence of workflow steps corresponding to each test order of the order list; and
generating a plurality of readiness commands for each target laboratory instrument, each readiness command for a particular target laboratory instrument considers a sum of transportation time of the biological sample from the pre-analytical laboratory instrument to each target laboratory instrument and a sum of processing time of the biological sample by the pre-analytical laboratory instrument and each target laboratory instrument preceding the particular target laboratory instrument in the sample workflow.

5. The method of operating an analytical laboratory according to claim 4, further comprising,
transmitting a readiness response by each target laboratory instrument, the readiness response being indicative of an estimated time of availability of when the target laboratory instrument will become ready to carry out the respective test order; and
re-determining the sample workflow for processing the biological sample by postponing processing of the biological sample by a first target analytical laboratory instrument if a second target analytical laboratory instrument will become ready earlier to carry out its corresponding test order.

6. The method of operating an analytical laboratory according to claim 1, wherein the step of determining whether the target laboratory instrument(s) is ready to carry out the test order comprises one or more of the following:
determining whether the target laboratory instrument is powered on and not in a low-power mode;
determining whether all modules of the target laboratory instrument required to carry out the respective test order are operational;
determining whether all consumables required to carry out the respective test order are available; and/or
determining whether all quality control and/or calibration values of the target laboratory instrument are up-to-date and valid;
and wherein the readiness command comprises instructions which, when executed by the target laboratory instrument, causes one or more of:
powering on respectively waking up the target laboratory instrument from a low-power mode;
all modules of the target laboratory instrument required to carry out the respective test order to be brought into operational state;
all consumables required to carry out the respective test order to be made available to the target laboratory instrument; and/or
carrying out of quality control and/or calibration steps to ensure all quality control and/or calibration values of the target laboratory instrument are up-to-date and valid.

7. The method of operating an analytical laboratory according to claim 1, further comprising,
retrieving a complete order list from a database, the complete order list comprising all test order(s) registered in the database that have not been completed;
identify a target laboratory instrument of the analytical laboratory for each of the test order(s) of the complete order list which is configured to carry out the at least one processing step according to the test order;
transmitting a standby command to any analytical instrument of the analytical laboratory not identified as target laboratory instrument for any of the test order(s) of the complete order list; and
switching the target laboratory instrument into a low power mode in response to the standby command.

8. The method of operating an analytical laboratory according to claim 1, wherein one or more of the target laboratory instrument(s) is an analytical laboratory instrument configured to carry out one or more analytical processing steps on the biological sample to determine presence and/or concentration of one or more analyte(s) in the biological sample.

9. An analytical laboratory, the analytical laboratory comprising:
one or more pre-analytical laboratory instrument(s) configured to receive and identify biological sample(s);
one or more laboratory instrument(s) configured to perform one or more processing step(s) on the biological sample; and
a control unit communicatively connected to the pre-analytical laboratory instrument(s) and analytical instrument(s), the control unit being configured to control the analytical laboratory to perform the method according to claim 1.

10. The analytical laboratory according to claim 9, wherein the one or more laboratory instrument(s) comprise one or more analytical laboratory instrument configured to carry out one or more analytical processing steps on the biological sample to determine presence and/or concentration of one or more analyte(s) in the biological sample.

11. The analytical laboratory according to claim 9, wherein the one or more laboratory instrument(s) comprise one or more post-analytical laboratory instrument(s) configured to perform one or more from the list comprising recapping, unloading, disposing and archiving of biological sample(s).

12. The analytical laboratory according to claim 9, wherein the one or more laboratory instrument(s) comprise a sample transportation system configured to transport biological sample(s) from a first laboratory instrument to a second laboratory instrument.

13. A computer program product comprising instructions which, when executed by a control unit of an analytical laboratory cause the analytical laboratory to perform the method according to claim 1.
